(19) United States
(12) Patent Application Publication
(10) Pub. No.: US 2025/0307297 A1
(43) Pub. Date: Oct. 2, 2025

(54) Document Correlation Optimizer

(71) Applicant: Broadsword Ventures LLC, Lorton, VA (US)

(72) Inventors: Mark Edwin Salesky, Lorton, VA (US); PJ Salesky, Lorton, VA (US)

(21) Appl. No.: 18/622,397

(22) Filed: Mar. 29, 2024

(51) Int. Cl. G06F 16/34; G06F 16/33

(52) U.S. Cl. CPC G06F 16/345; G06F 16/334

(57) ABSTRACT

A method for calculating the correlation of the complete textual contents of one document to another one or many documents, to assess, compare and improve the responsiveness of one document to another, of which many possible uses are contemplated. This method comprises deconstruction of each word within said documents into its root form and the application of statistical metrics, then generating various visual presentations of that correlation and associated data. Further, the method is implemented in a system of software code and algorithms. The method and system have great utility for the User in determining the degree of responsiveness of one document to the other; one embodiment being to improve the responsiveness of a business proposal to a business solicitation. Many other embodiments may be contemplated across many disciplines which use digital text documents for analysis, comparison, evaluation, and decision making.

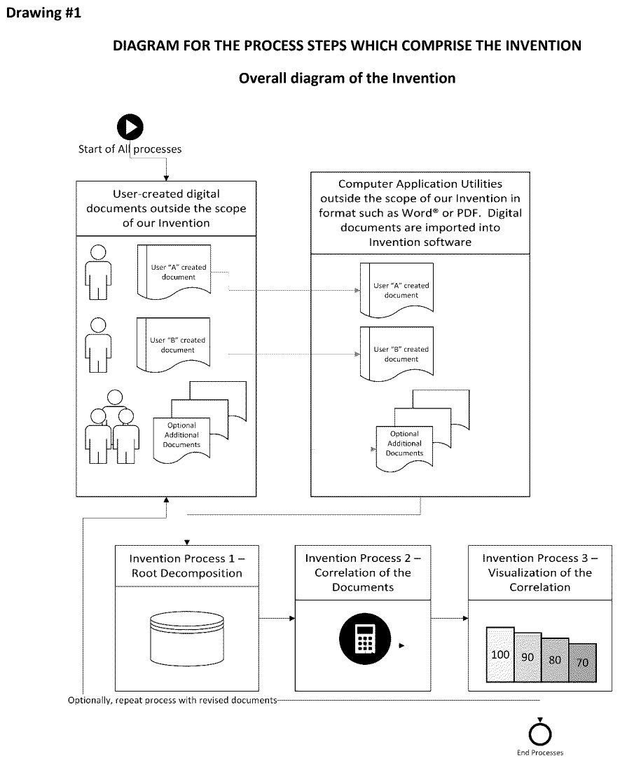

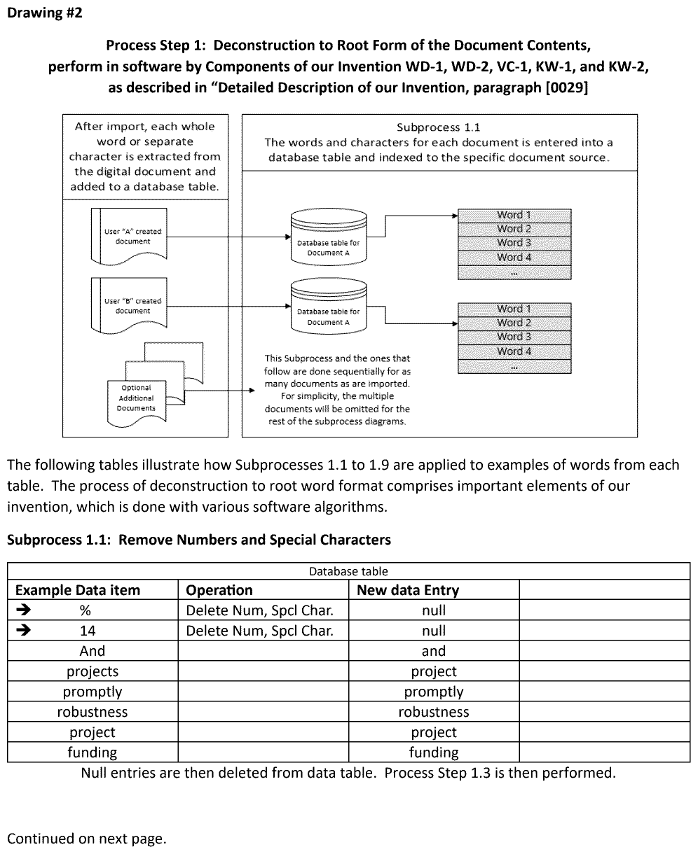

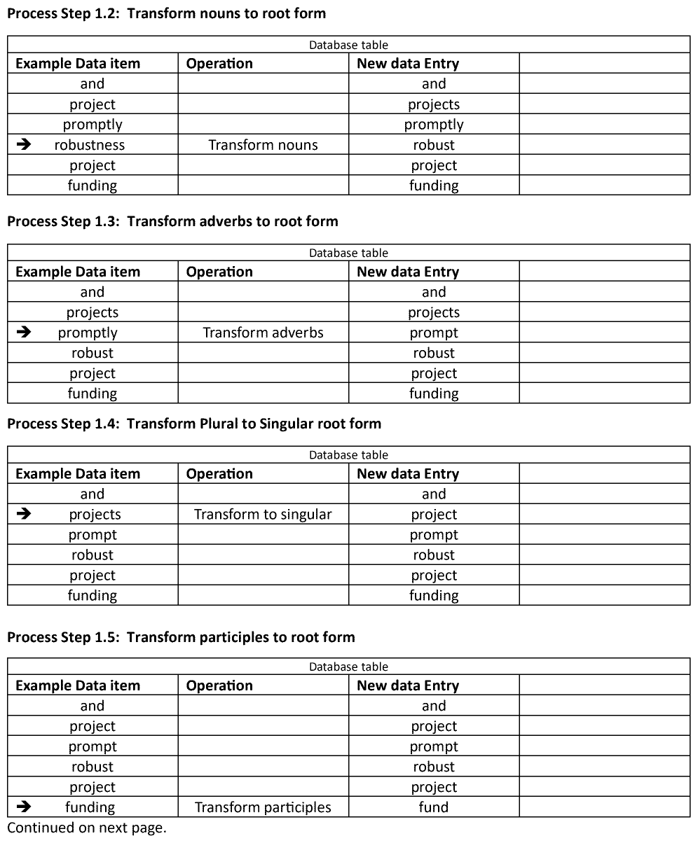

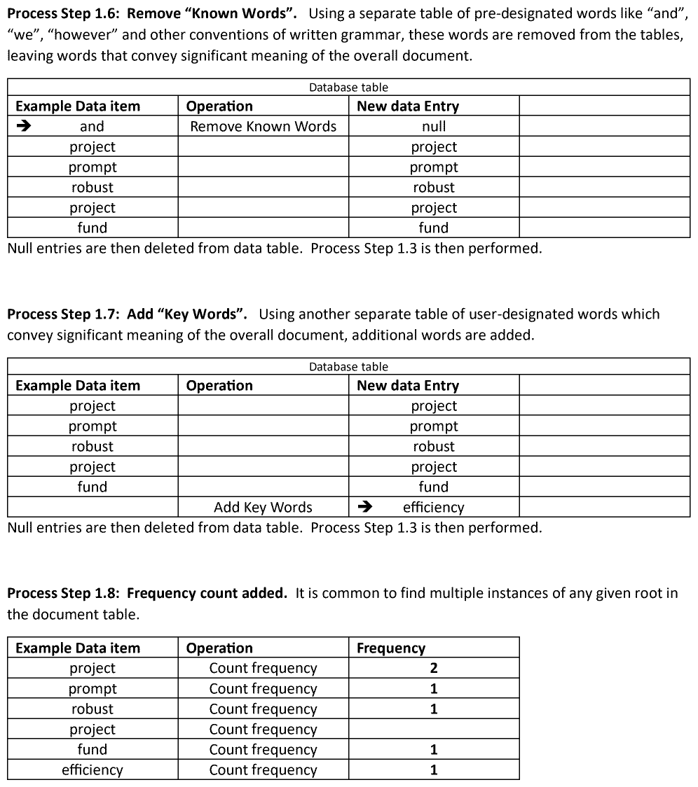

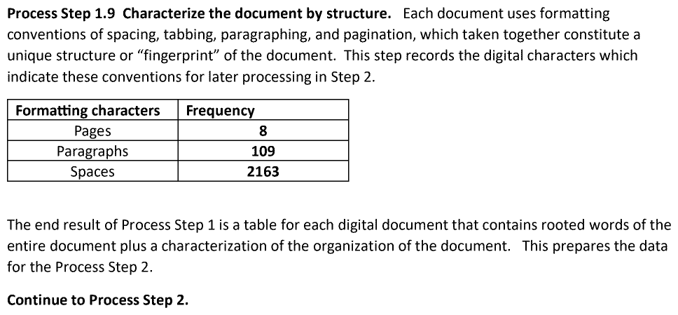

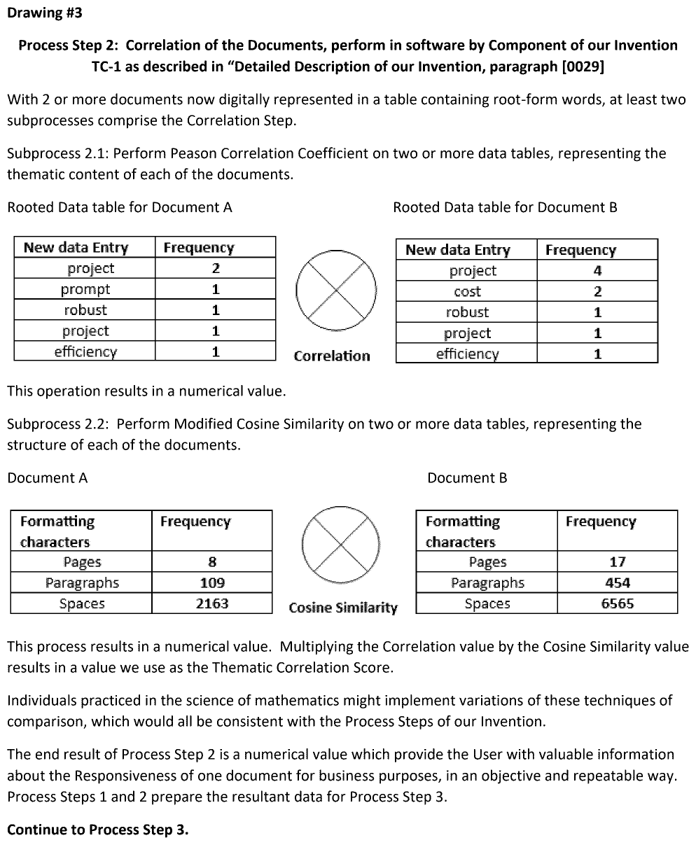

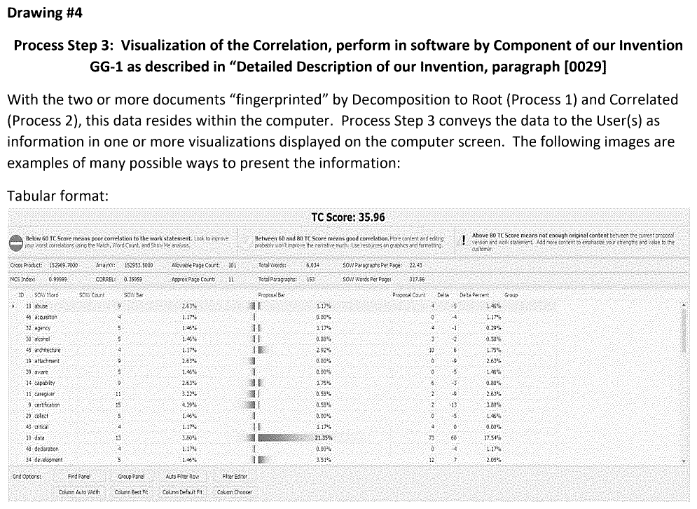

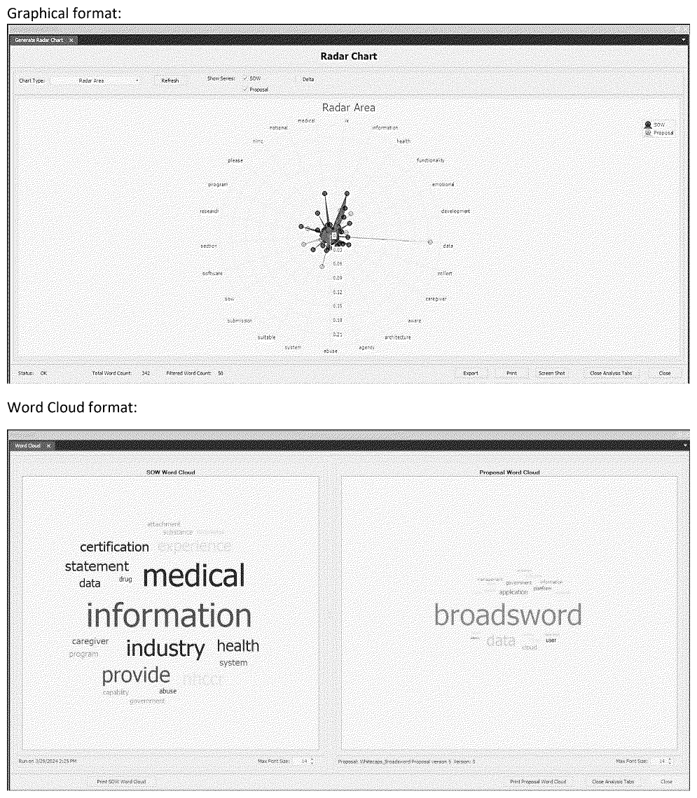

### CROSS-REFERENCE TO RELATED APPLICATIONS

A Provisional Patent Application was submitted with receipt confirmation by USPTO on Apr. 16, 2023 at 5:00 PM ET, under the Title “Document Correlation Optimizer”, Application No. 63/496,308.

### REFERENCE TO A “SEQUENCE LISTING”, A TABLE, OR A COMPUTER PROGRAM LISTING

This is a Utility Patent Application for a method and system implemented in software. The process steps are described in the Detailed Description of the Invention section and further illustrated in the Drawings section.

### BACKGROUND OF THE INVENTION

### Field of the Invention

This invention is related to information analysis, and more particularly, to the ability to objectively assess how well one document correlates to another, the results of this correlation to help the author achieve a goal of responsiveness. This method and system bridge the divide between manual and automated analysis as applied to whole documents, to inform the user of the meaningfulness of the correlation. These terms are further described below in the “Summary of the Invention” section.

### Description of Related Art

Information technology has been used extensively for the purpose of composing, editing, searching for, and retrieving written documents represented in digital format. But there are limitations. Because the totality of a written document is unique in composition, meaning, and other nuances that emerge from the creative efforts of the author(s), information technology has focused mostly on atomic operations; that is, algorithms and processing applied to smallest element of written text, such as individual characters (i.e., “use a period, not a comma”) or individual words (i.e., spell checking). In short, written documents are inherently qualitative and unique, like how a fingerprint is common to all persons and at the same time unique to each person.

In contrast, numerical data is much more easily processed in digital format, and there is enormous proliferation of analytical techniques using mathematical calculations (e.g., spreadsheets and algorithms). Search engines and related internet-based algorithms are generally applied to linking one search term or phrase with another, presenting the User with a logical connection to another document, but leaving the User to determine whether the document is thematically well-matched to the inquiry. In other words, the computer identifies the possible related documents, but the reader must actually read and then assess the relevance using his own judgment and intuition. This is why a Google search can return thousands, even millions of possible matches.

Our invention is not a search utility at all because search applications which use a form of correlation depend upon the description of the document as presented in the title, metadata, or key phrases. In clear contrast, our invention processes the entire content of the documents of concern, and produces useful metrics to quantitatively show if the author is really “answering the questions posed.” This becomes very clear in the scenario that motivated this invention: the preparation and submission of competitive business proposals. In this scenario, it is common for the seller of goods or services (“seller”) to prepare a proposal at arms-length from the buyer, sometimes at great expense, only to be technically compliant in format, general content, timeliness, and all other instructions, but not responsive to the buyer. In this case, responsiveness is both an objective and subjective criteria that is extremely elusive since it addresses the proposal document as a whole. With some written proposals consisting of dozens, even hundreds of pages, the degree of “responsiveness” to the needs, desires, and preferences of the buyer, is usually a human judgment, sometimes made by committee, and always subject to bias, omission, and unrealistic optimism. Our invention bridges that bias with quantitative information that is consistent, repeatable, and objective.

Another example of current related art that does not bridge the qualitative/quantitative gap in document processing is something close to home—the patent search. The USPTO patent search makes use of Boolean logic (“and/or” queries applied across multiple metadata criteria (e.g., author, title). This is the classical and proven search methodology used in infinite ways in Information Technology applications. It yields a list of patents which are related . . . but are they responsive to the inquirer's search? The inquirer must still read the application to determine that.

These two scenarios in the preceding paragraphs describe in general terms the limitations of much of the information technology application in current art.

It is also important to recognize that many software apps perform a “correlation,” which is not defining of any specific process, method or technique, but rather, indicates a relationship or connection. In fact, there are many correlation techniques, including common methods such as Scatter Diagram Method; Karl Pearson's Coefficient of Correlation; Spearman's Rank Correlation Coefficient; and Methods of Least Squares. The term “correlation” in any context is only generic until applied in specific formula, algorithm, and technique. In many applications different than ours, the intent of the method or software is to “find” another document based on an algorithmic correlation, typically ranking them in a rough order of relationship. Underlying all these approaches is the concept of keywords, which are weighted in importance than all other words, and thereby establish a ranking which may (or may not) be satisfactory to the user. The usage of ranking keywords is a computationally efficient process, but rarely yields results that are exactly to the user's intent. This is fundamentally the reason for using the Internet, everyone has the experience of doing multiple searches and scrolling through many possibilities before finding a satisfactory response. Our invention does not make use of this keyword correlation technique.

### SUMMARY OF THE INVENTION

This invention is a new and novel process and system which provides a user with mathematically derived correlation score based on the thematic content of two or more written documents of interest. The method decomposes the document into individual words or phrases, deconstructs or reduces them into their root form, organizes the deconstructed words into a data structure which enables mathematical calculations, then presents the results in one or more visual formats wherein the overall correlation, referred to as the Thematic Correlation Score (TC Score), indicates both the relative degree of responsiveness and also a guide to improve that responsiveness in successive versions of the document(s).

This method implements several concepts and terms as generally defined here. Specific implementation may vary with the application and implementation as a system. All of these are stated in the context of written documents in digital format. The use of the term “party” can mean a single person, team, collective body, business or corporate entity, wherein:

“Responsiveness” means the degree of satisfying the intent or request by one party, by the written reply of a second party, with a mutually agreeable outcome. Responsiveness is agnostic to the form or common name of the reply, e.g. it could be a “proposal” in the context of business, a “plea” or “argument” in the context of legal.

“Meaningfulness of the correlation” means the degree to which a User can judge how one or more documents are mathematically similar to another document or documents in order to satisfy the interests and intent of the User.

“Correlation” means the connection or relationship between two or more documents as measured in a mathematical way (often using statistical methods), which can be applied to or expressed in many ways, such as appearance, format, and perceived quality.

“Thematic content” means the totality of words in context of their root meaning, regardless of syntax or grammar. Thematic correlation is distinguished from other meanings of correlation by the deconstruction of any word to and comparative analysis of its grammatical root format. For example, the word “robustness” is deconstructed to “robust”, and “employees” is deconstructed to “employee.”

“Thematic Correlation Score (TC Score)” is the term our invention uses to quantify the results of our Processes as a numerical value.

Our invention also comprises a system of computer code which implements this method, with various utilities and functions which are common computer applications, but uniquely comprises the presentation of one or more visual representations of the thematic correlation as illustrated in drawings 1 through 4.

Our system which implements our method comprises computer code in specific parts, which carry out the claimed steps, as shown in the drawings. The only required inputs to the system are two or more written documents which can be read by a computer program as individual characters: typical digital formats are .txt, .doc, .docx, and .pdf. All processing steps conducted by the system are relative to the documents.

Our invention differs from other document correlation methods and systems because it does not rely upon a keyword or phrase indexing, which is core the vast majority of the document search-and-retrieve systems operating on the Internet, public, or private networks.

Our invention further differs from other document correlation methods and systems because it uses a method to deconstruct the entire document content to achieve a basis of correlation between two or more documents, whereas other systems perform matches based on the title, summary, abstract or metadata which merely describes the content of the document. This feature is illustrated in drawing 2 titled “Invention Process 1—Deconstruction to Root Form of the Document Contents.”

Our invention further differs from other document correlation methods and systems because it measures correlation relative to the entire deconstructed contents of the documents (referred to as the TC Score) without reference to any external baseline or template, whereas other systems make use of ranking orders, weighting, or other externally set parameters that determines the rank order of matching. This feature is illustrated in drawing 3 titled “Invention Process 2—Correlation of the Documents.”

Our invention further differs from other methods and systems by applying the TC Score to various visual presentations within the application, thereby providing contextual information like but not limited to magnitude, statistical frequency, pattern matching, and prioritization of the poor correlations. This feature is illustrated in drawing 4 titled “Invention Process 3-Visualization of the Correlation and Summary Statistics between the Documents.”

Our invention further differs from other documentation analysis methods and systems because it produces metrics which are visually presented to the user in a graphical or tabular format, which allows the user to judge the Meaningfulness of the Correlation.

Our invention further differs from other documentation analysis methods and systems because it records the significant calculations of each iteration, enabling the User to make improvements in the prose, logic, and emphasis of important thematic elements, which are fundamental to the User's objectives of Responsiveness. Whereas other systems merely present data for user interpretation.

Our invention further differs from other methods and systems by the utility of presenting visual representations as described in the preceding paragraph, which enable and guide the user to make active changes and improvements in subsequent rewrites/versions of the document.

The features and advantages described in this summary and the following detailed description are not all-inclusive. Many additional features and advantages will be apparent to one of ordinary skill in the art, in view of the drawings, specification, and claims.

### BRIEF DESCRIPTION OF DRAWINGS

Drawing #1 is the diagram for the process steps which comprise the invention.

Drawing #2 is the Process Step 1: Deconstruction to Root Form of the Document Contents.

Drawing #3 is the Process Step 2: Correlation of the Documents.

Drawing #4 is the Process Step 3: Visualization of the Correlation

### DETAILED DESCRIPTION OF THE INVENTION

Our invention comprises 7 separate software components which perform the steps of our method and actualize the method in our software system. While listed in series on the table that follows, within the computer one or more of these steps are performed concurrently, making use of the nature of software parallel operations. These 7 components are described as follows and further illustrated in the “Drawing” section.

TABLE 1
List of Process Components of our Invention as a Method

| Component | Component | |
|---|---|---|
| Reference ID | Name | Process Description |
| WD-1 | Word | This is the process of dividing the uploaded document into |
| | deconstruction | individual words and special characters and storing this information |
| | | in the database, inclusive of but not limited to the following word |
| | | conversions: 1) plural to single, 2) remove “-ly”, 3) remove “-ness”, |
| | | remove special characters and numbers, and 4) remove “-ing”. |
| WD-2 | Word | This process creates a frequency model of the deconstructed words |
| | tabulating | for any one document as a preliminary step to correlation analysis. |
| | | It writes the results into the application database. |
| VC-1 | Version Control | Each version of the non-reference document (i.e., the proposal, |
| | | reply, offer, etc.) is recorded in the application database alone with |
| | | the specific metrics and calculations that apply uniquely to that |
| | | version. The system displays each version in the User Interface, |
| | | and allows for the analysis visual presentations to be reconstructed |
| | | on demand. |
| KW-1 | Processing of | This process performs a database operation that deletes or |
| | Known Word | exempts from the document word frequency table all the words |
| | List (KWL) | that are contained in the KWL. This reduces the number of entries |
| | | in the frequency table, removing all words and phrases which are |
| | | common and thematically irrelevant. The KWL is an evolving set of |
| | | words, phrases, or characters, which is updated periodically and |
| | | incorporated into the software version release. |
| KW-2 | Processing of | This process performs a database operation that deletes or |
| | Registered | exempts from the document word frequency table all the words (in |
| | Word List | deconstructed form) that are contained in the RWL. The RWL is a |
| | | set of words, phrases, or characters which is inputted by the User |
| | | of the software via a screen form, and makes it unique to the |
| | | specific case (i.e., the proposal, reply, offer, etc.). |
| TC-1 | Thematic | This process performs the calculation of a Thematic Correlation |
| | Correlation | Score (TC Score), using one or several mathematical techniques to |
| | | uniquely characterize the document under analysis. One |
| | | implementation makes use of a signal processing technique known |
| | | as the Pearson Correlation Coefficient (PCC), described briefly in |
| | | Reference [0039]. Another implementation makes use of another |
| | | technique known as Modified Cosine Similarity (MSC), described |
| | | briefly in Reference [0040]. The application of these techniques |
| | | alone, together, or in combination with other mathematical |
| | | variations, which are known to one skilled in math and statistics, |
| | | are used to compare the unique digital “fingerprints” of each |
| | | document in the form of data arrays, comprised of both the words |
| | | and structure of the imported documents. That statistical |
| | | comparison of the entirety of the document thereby answers the |
| | | question “how responsive is one document to the other?” which is |
| | | a valuable insight for a variety of scenarios as suggested by our |
| | | Embodiments in paragraphs [0034] through [0037]. |
| GG-1 | Generating | This process generates the visual presentations of the |
| | visual | meaningfulness of correlation (described earlier), which shows the |
| | presentations | digital “fingerprint” of the versioned document in comparison the |
| | of the Thematic | reference document, along with the mathematical calculations that |
| | Correlation | support those presentations, including but not limited to the TC |
| | Score (TC | Score. Other calculations may be statistical expressions (e.g., mean, |
| | Score). | average, percent), second-order metrics (e.g., percent |
| | | improvements), or text reference data (page location of certain |
| | | thematic words). The visual presentations include identifying data |
| | | to support version control. All of these visual presentations assist |
| | | the User in determining the Responsiveness, which in turn allows |
| | | iterative improvements to achieve a mutually agreeable outcome |
| | | between the parties. |

Additional components are common industry elements incorporated into the system so that it is compatible with the current and future state of computing technology. These additional components also perform specific processes which may be implemented in by various software technologies, and will evolve over time. They are analogous to a framework or rigging, within which our invented components operate interactively. The specific software which implements these components may vary over time, and work with our invented components as an integrated system. This set of components are not the subject of our Invention, but are provided here to illustrate the nature of complex modern software comprised of many individual components working together.

TABLE 2
a list of common software utilities which combined with our
Invention implements our methods as a Software System.

| Component | Component Name | Process Description |
|---|---|---|
| IN | Installation | This process installs the app from a downloaded file. |
| | | It produces an executable file which, when opened, |
| | | prompts various processes (licensing, etc.). |
| LA | License activation | License activation is by a password or similar access |
| | | control. |
| DB | Included DB | This is the creation and operation of a database that |
| | | serves to record all ingested and generated data for |
| | | the application. |
| IG | Ingestion of | This process allows the User to upload a file from the |
| | text documents | host platform, either .doc, .docx, .pdf, or .txt. |
| MS | On screen messages | Information provided to the User about the processes |
| | | and buttons on the screen |
| TR | Training | User guides/manuals and training videos which are |
| | | common to the industry are part of the overall |
| | | system. |
| RP | Report Generation | This process creates a formatted report with the data |
| | | elements cited in GG-I, above, and enables paper |
| | | printing. |

### Statement of Utility

Our invention has specific and substantial utility for any User desiring to evaluate the degree of Responsiveness between one document (an inquiry, solicitation, plea, position, or and other written expression of need or want), and another document(s) (a bid, proposal, application, resume, or reply), and to do so over multiple iterations with guided improvements. There are many possible utilities for our invention, several embodiments are described as follows.

In one embodiment, this method and system is used to compare two documents, such as a business solicitation issued by a buyer, and the other a business proposal prepared by a seller. The generation of the TC Score with the various visual representations provides a consistent, objective, repeatable, and auditable measure of responsiveness, that being a primary objective of the seller as a means of winning the solicitation. In this instance, the seller, wishing to be selected as most responsive to the specifications of the solicitation, writes successive versions of the proposal, each with revisions to increase the TC Score to a satisfactory point in time or effort. The results of using our invention is to increase the likelihood of being selected as the winning proposal.

In another embodiment, this method and system is used to compare multiple documents to one document, such as multiple submitted proposals from various sellers to a buyer's solicitation (effectively the reverse of the first cited embodiment). In this way, the buyer can assess the degree of responsiveness as represented by the TC Score, providing a consistent, unbiased, repeatable, and auditable measure to support the selection of a single seller, or alternatively to select multiple sellers above a threshold. The results of using our invention is to select the most responsive seller as measured by the TC Score.

In another embodiment, this method and system is used to compare multiple documents to one document, such as multiple submitted resumes to a job posting. The degree of responsiveness as represented by the TC Score provides a consistent, unbiased, repeatable, and auditable measure of responsiveness, that being a primary objective of the hiring person or company as a means of selecting candidates, or alternatively, of revising the job description to better address the market. The results of using our invention is to reduce the amount of time and effort in screening the resumes by using the TC Score to identify the most responsive candidate, or failing a desired responsiveness, to revise the narrative of the job.

In another embodiment, this method and system is used to compare multiple documents to one document, such as multiple submitted academic written works to a single course outline or writing prompt. The degree of responsiveness as represented by the TC Score provides a consistent, unbiased, repeatable, and auditable measure of responsiveness, that being a primary objective of the academic instructor or institution as a means of grading scholars/applicants, or alternatively, of revising the course objectives to improve the learning materials. The results of using our invention is to reduce the amount of time and effort of grading scholarly works by using the TC Score to identify how responsive students/candidate, or failing a desired responsiveness, to revise the outline objectives of the course.

We can envision many other scenarios where an objective and repeatable process of correlating documents relative to each other will provide a benefit of time, effort, and mutual acceptability of the authoring parties, driven by their ingenuity and unique needs.

### REFERENCES

Pearsons Correlation Coefficient, a well-known mathematical formula used in many data applications, as described on the website https://www.statology.org/pearson-correlation-coefficient/, in short, is a measure of the linear association between two variables X and Y, in our implementation, X and Y being two different documents.

$${r}_{xy} = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2}} \sqrt{{\sum }_{i = 1}^{n} {( {y}_{i} - \overline{y} )}^{2}}}$$

Modified Cosine Similarity, a well-known mathematical formula used in many data applications, as described on the website https://en.wikipedia.org/wiki/Cosine_similarity, in short, is a measure of resemblance; i.e., how similar or alike things being compared are.

$$cos ( θ ) = \frac{A \cdot B}{‖ A ‖ ‖ B ‖} = \frac{{{\sum }_{i = 1}}^{n} {A}_{i} {B}_{i}}{\sqrt{{{\sum }_{i = 1}}^{n} {A}_{i}^{2}} \sqrt{{{\sum }_{i = 1}}^{n} {B}_{i}^{2}}}$$

1. The invention claimed is a method of calculating the correlation of the thematic content of two or more written documents which contain text in digital format comprising, 1) decomposing the digital formats of those documents into a list of words in root word form; 2) tabulating the occurrence of those words in each document and recording them into an information arrangement (I.e. table or similar data structure); 3) correlating said information arrangements, said correlation analysis being a mathematical formula that produces a summary value for that specific analysis; 4) recording each analysis corresponding to the series of versions of the said written documents; 5) visually representing the correlation of the original two documents or successive versions of those documents in visual presentation of said correlation; and 6) repeating the processes on successive or iterative versions of the said written documents.

2. The method according to claim 1, wherein the words recorded from each of the reference and versioned document are deconstructed to their grammatical root.

3. The method according to claim 1, wherein the visual representations of said analyses is a graph, list, table, array of words, hyperlink, document, symbol, or any combination thereof, which convey to the user the Meaningfulness of the Correlation.

4. A system that implements the method according to claims [1], [2], and [3] for storing and processing two or more digital documents, comprising a software package of instructions and controls that 1) imports, reads and stores textual information from data files; 2) records and performs operations from user input; 3) applies mathematical analyses to the content of those documents; 4) organizes and manipulates that textual information into one or more data structures such as tables; 5) applies one or more mathematical formulae for calculating the correlation scores; 6) renders graphs and charts to visually shows the differencing of said textual information; and 7) stores said data and calculations into memory for the purpose of repeating the described processes on successive versions of the document(s).

5. The system according to claim [4] wherein the textual content in the documents read by the system are decomposed into their root forms and stored in a system table with the count of occurrence, relative position of occurrence, and statistical data.

6. The system according to claim [4], wherein the calculations are stored in both persistent memory and in a data file that can be used to retrieve said calculations at a later time and across working sessions for the purpose of reassembling the mathematical analyses and visual presentations.

7. The system according to claim [4], wherein the analyses and various related data elements are presented via graphs, tables, and other visual elements on-screen which illustrate the degree or correlation between or among said documents, allowing the user a consistent, unbiased, repeatable, and auditable measure of responsiveness.
